(19) United States
(12) Patent Application Publication
(10) Pub. No.: US 2003/0038403 A1
(43) Pub. Date: Feb. 27, 2003

(54) Machine and method for providing folded pipe liners

(75) Inventor: Mark A. Thompson, Marysville, OH (US)

Correspondence Address: MILES & STOCKBRIDGE PC, 1751 PINNACLE DRIVE, SUITE 500, MCLEAN, VA, 22102-3833, US

(73) Assignee: American Pipe & Plastics, Inc.

(21) Appl. No.: 10/216,269

(22) Filed: Aug. 12, 2002

Related U.S. Application Data
(60) Provisional application No. 60/313,498, filed on Aug. 21, 2001.

(51) Int. Cl. B29C 53/08; B29C 63/34

(52) U.S. Cl. 264/269; 264/284; 425/329; 425/392

(57) ABSTRACT

A machine and method for providing a folded liner for insertion into a pipe, comprises an upper section and a lower section. A flattened heated thermoplastic liner is fed downwardly through the upper section to the lower section, where it is redirected and fed substantially horizontally from the lower section. The flattened liner introduced to the upper section is broadly indented at one side of the liner and is then folded to provide loops disposed side-by-side in a substantially horizontal direction. A stabilizing assembly constrains the loops to maintain a desired orientation of the folded liner. The lower section redirects the liner so that the loops are stacked side-by-side in a substantially vertical direction. The liner is cooled as its leaves the lower section to maintain its cross-sectional configuration. The upper section is separable from the lower section, and portions of the upper and lower sections are displaceable and removable to facilitate insertion of the liner into the machine and removal of the machine from the liner.

### CROSS REFERENCE TO RELATED APPLICATION

This application claims the benefit of provisional application No. 60/313,498 filed Aug. 21, 2001 (incorporated herein by reference).

### BACKGROUND OF THE INVENTION

This invention is concerned with lining of sewer pipes and the like and is more particularly concerned with providing a folded liner that can be pulled through a pipe for later expansion by conventional techniques.

Because of the expense of repairing and/or replacing defective sewer pipes and the like, an industry practice has developed in which the pipes are lined with a plastic liner, thereby to provide a new flow path within the defective pipe. In order to facilitate the pulling of the liner through the pipe, techniques have been developed for folding a flattened thermoplastic liner before it is introduced to the pipe so that the cross-dimensions of the liner, when folded, are substantially less than the cross-dimensions of the pipe. However, providing a folded liner efficiently, reliably, and economically has been a problem. The present invention is a solution to that problem.

### RELATED PRIOR ART

Commonly owned prior application No. 09/629,174 filed Jul. 31, 2000 (incorporated herein by reference), describes a machine and method for providing pipe liners. The machine of the prior application, which can be installed in a manhole, comprises an upper section and a lower section that are preferably separable. As a heated flexible liner is fed into and through the upper section to the lower section, it is broadly indented at one side thereof and is then folded so that the liner cross-section assumes a configuration in which a pair of outer loops are disposed at opposite sides of a central loop. The central loop has an open end that defines a longitudinal groove in the folded liner. An assembly comprising a disk that rotates about a substantially horizontal axis and a finger below the disk is inserted into the longitudinal groove and tends to maintain the liner orientation as the liner is fed through the upper section and into and through the lower section, which redirects the liner. However, there are circumstances in which the orientation of the liner can change, undesirably.

This problem can occur if a cold section of the liner is encountered as the liner moves through the upper section or if the liner has not been heated adequately. In the invention of the prior application, the longitudinal groove at one side of the folded liner may momentarily turn by 90° left or right, or even by 180°, significantly increasing the force required to pull the liner through the machine and unduly stressing the liner. This problem is not likely to occur if the temperature of the liner in the upper section is maintained above 160° F., but it may not be possible always to maintain such a temperature in colder climates.

### BRIEF DESCRIPTION OF THE INVENTION

The present invention concerns an improvement in the machine and method of the prior application. The purpose of the improvement is to keep the liner from rotating about a longitudinal axis and changing its orientation as it is fed through the upper section of the machine. The improvement maintains the desired orientation of the liner, even if a cold section is encountered or the liner is inadequately heated, reducing the need for a highly skilled operator.

In accordance with the present invention, tubing that is folded about a longitudinal axis to form overlapping loops, including a central loop open at an end thereof, and loops at opposite sides of the central loop, is stabilized by a group of guides that surround and embrace the folded tubing and by a divider that is inserted into a longitudinal groove of the tubing defined by the open end of the central loop.

### BRIEF DESCRIPTION OF THE DRAWINGS

The invention will be further described in conjunction with the accompanying drawings, which illustrate a preferred and exemplary (best mode) embodiment of the invention and wherein:

FIG. 1 is a perspective view of the upper section;

FIG. 2 is a perspective view of a removable portion of the upper section;

FIG. 3 is a further perspective view of the upper section and a portion of the lower section, showing components that are not visible in FIG. 1 and showing the cross-sectional configuration of the liner after folding;

FIG. 4 is a top plan view of the upper section showing the cross-sectional configuration of the liner as it is broadly indented;

FIG. 5 is a perspective view of the lower section;

FIG. 6 is a fragmentary perspective view showing displacement of a removable portion of the lower section;

FIG. 7 is a perspective view showing the lower section with the removable portion of FIG. 6 removed;

FIG. 8 is a side elevation view showing the upper section assembled on the lower section;

FIG. 9 is an end view of the machine shown in FIG. 8, illustrating the cross-sectional configuration of the folded liner as it leaves the lower section;

FIG. 10 is an inverted perspective view of a cooling manifold that can be used in the invention;

FIG. 11 is an enlarged horizontal sectional view taken along line 11-11 in FIG. 8;

FIG. 12 is a fragmentary vertical sectional view taken along line 12-12 in FIG. 11; and

FIG. 13 is a side elevation view of a hinge plate employed in the invention.

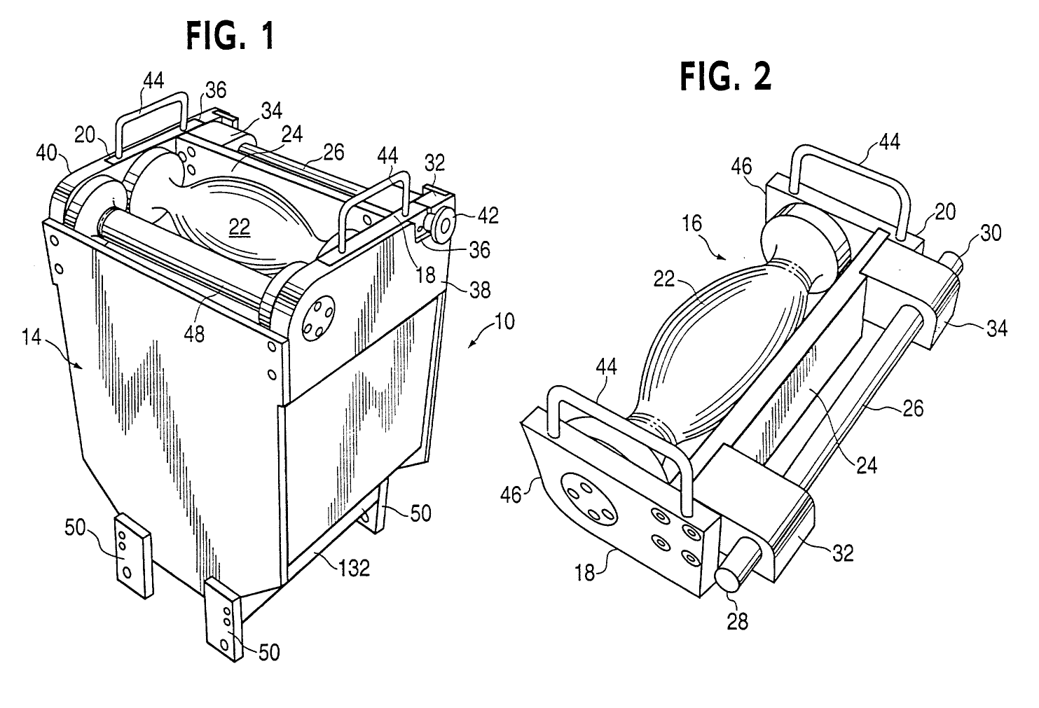

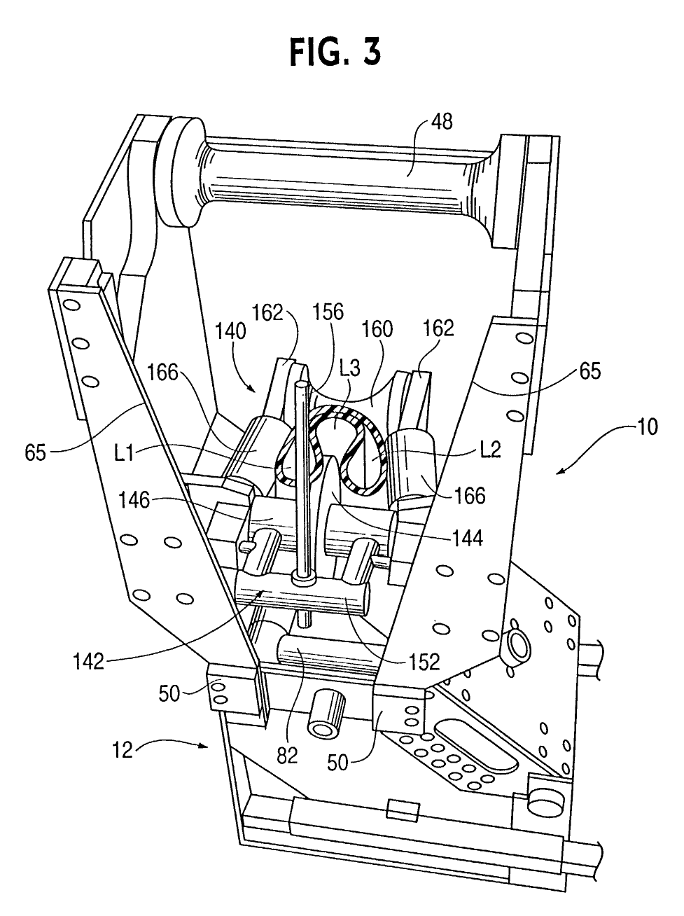

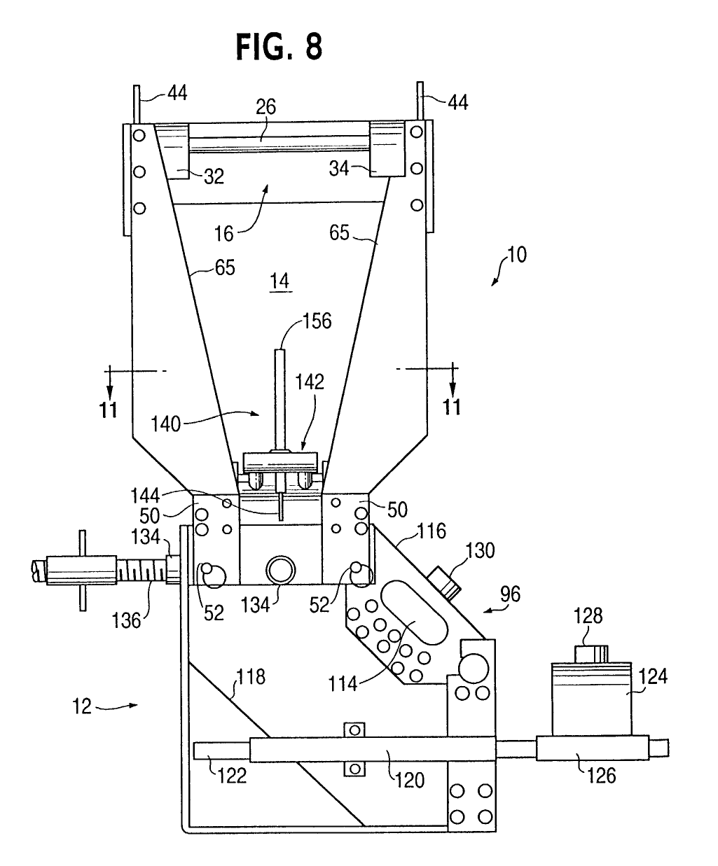

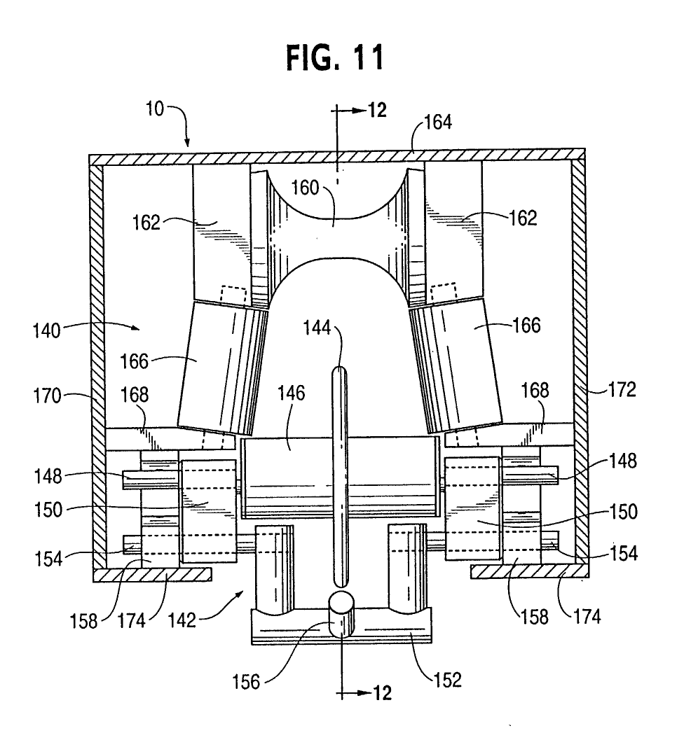

In the drawings, FIGS. 1, 2, 4-7, 9 and 10 are identical to the same-numbered figures of the prior application. FIGS. 3 and 8 correspond to the same-numbered figures of the prior application modified to show the improvement of the present invention. In FIG. 3 a portion of the lower section has been added. FIGS. 11-13 relate specifically to the improvement of the present invention.

### DETAILED DESCRIPTION OF THE INVENTION

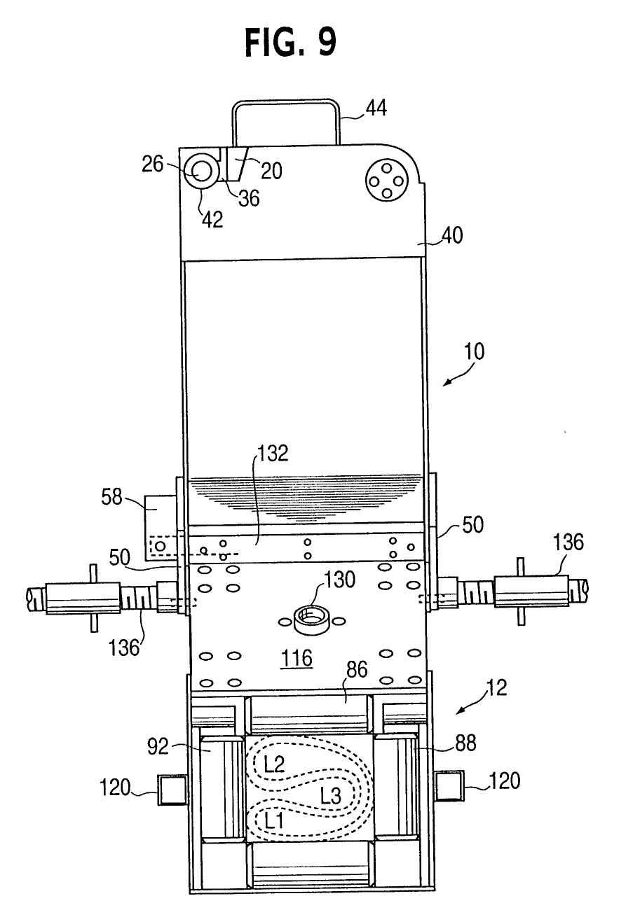

As shown in FIGS. 8 and 9, a machine in accordance with the invention comprises an upper section 10 mounted on a lower section 12. The upper section, shown more particularly, in FIGS. 1-4, comprises a casing 14 that is open at the top and at one side thereof. A portion 16 of the upper section, shown in FIG. 2, is displaceable and can be removed from the remainder of the upper section. Removable portion 16 comprises a pair of side plates 18, 20 supporting a convex, bulbous forming roller 22 that is mounted rotatably on the side plates.

An end plate 24 connects the side plates and supports a rod 26 with ends 28, 30 that project from a pair of mounting brackets 32, 34 attached to the end plate. The projecting ends of the rod are received within L-shaped slots 36 in sidewalls 38, 40 of the upper section, the sidewalls being notched to receive the side plates of the removable portion 16. Washers 42 (FIGS. 1 and 9) may be attached to the projecting ends of the rod 26.

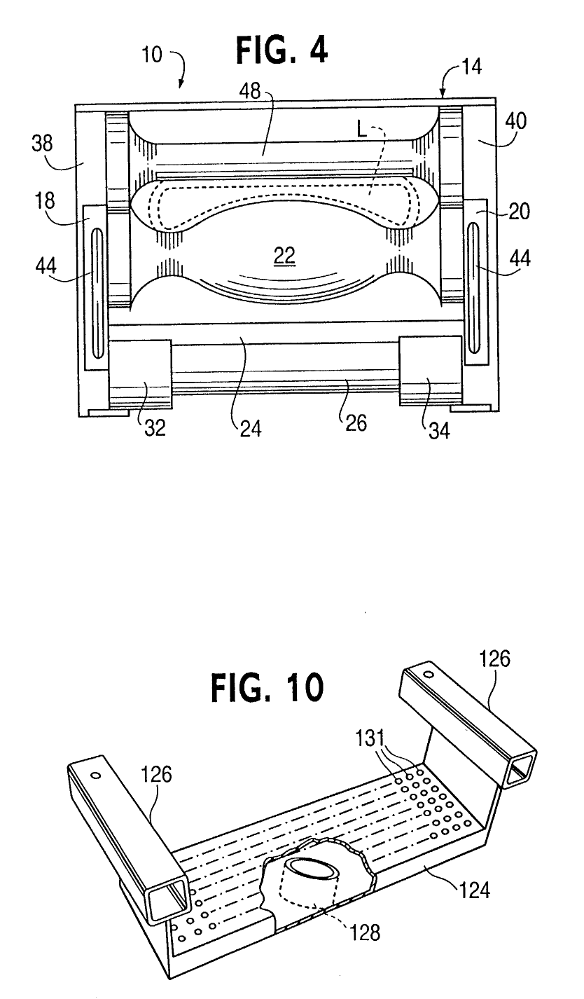

Handles 44 are mounted on the side plates of the removable portion so that the removable portion can be easily turned and lifted from the position shown in FIG. 1. The ends 46 of the side plates, opposite to the projecting ends 28 of the rod 26, are curved, and the juxtaposed surfaces of the sidewalls 38 and 40 have a complementary curvature, so that the removable portion can be turned about the axis of the rod 26 and then shifted along slots 36 and lifted out of the slots. As shown in FIGS. 1 and 4, a cylindrical backup roller 48 is rotatably supported on the sidewalls of the upper section in close proximity with the forming roller 22. The forming roller 22 and the backup roller 48 rotate about substantially horizontal axes.

Four rectangular plates 50 are attached to and extend downwardly from a bottom portion of the upper section to embrace a top portion of the lower section 12 as shown in FIGS. 8 and 9. Removable pins 52 are inserted into aligned bores in the plates and the juxtaposed walls of the lower section.

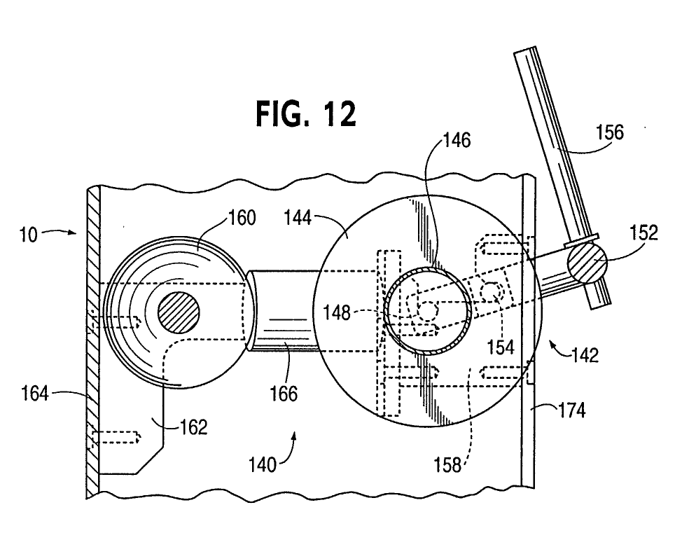

As shown in FIG. 3 (from which the displaceable portion 16 of the upper section has been removed in order better to view the invention), and as also shown in FIG. 11 and 12, a stabilizing assembly 140 in the upper section 10 includes a removable unit 142 having a divider disk 144 fixed centrally on a roll 146 that is supported rotatably by bearings on axle rods 148 projecting from opposite ends of the roll. The axle rods extend through blocks 150 so as to project outwardly therefrom and are pinned thereto.

A U-shaped frame 152 has a pair of rods 154 fixed thereto and projecting outwardly from the blocks 150, being pinned thereto parallel to the rods 148. A removable handle 156 projects from the frame 152 and is used in mounting the removable unit 142 on supports (hinge plates) 158 fixed within the upper section 10, and in demounting the removable unit 142, as will be described later.

In addition to the roll 146 of the removable unit 142, the stabilizing assembly includes a concave backing roll 160 (or a straight backing roll) supported rotatably on plates 162 affixed to a wall 164 of the upper section 10, and side rolls 166 supported rotatably on the plates 162 and on additional plates 168 fixed to walls 170 and 172 of the upper section. The plates 168 also serve to support one end of the hinge plates 158, the opposite end of which is supported on a wall 174 of the upper section. As shown in FIG. 11, the side rolls 166 are angulated with respect to one another, so that they converge toward roll 160.

Each hinge plate 158 has slots 176 and 178 (see FIGS. 12 and 13) for receiving corresponding rods 148 and 154 that project outwardly from the blocks 150 of the removable unit 142. To mount the unit 142 on the upper section, the handle 156 is used to lower the rods 154 onto horizontal upwardly facing surfaces 180 of the hinge plates 158, and the rods 154 are then slid into slots 178. Then the handle 156 is used to turn the unit 142 so that the rods 148 are seated in the slots 176. The handle may then be removed.

The hinge plates 158 are chamfered a shown at 182 and 184 to facilitate movement of the rods relative to the corresponding slots. As shown in FIG. 12, when the unit 142 is fully installed in the upper section, the frame 152 is slightly over center, which assists in holding the unit in place, particularly when the roll 146 is engaged by a liner.

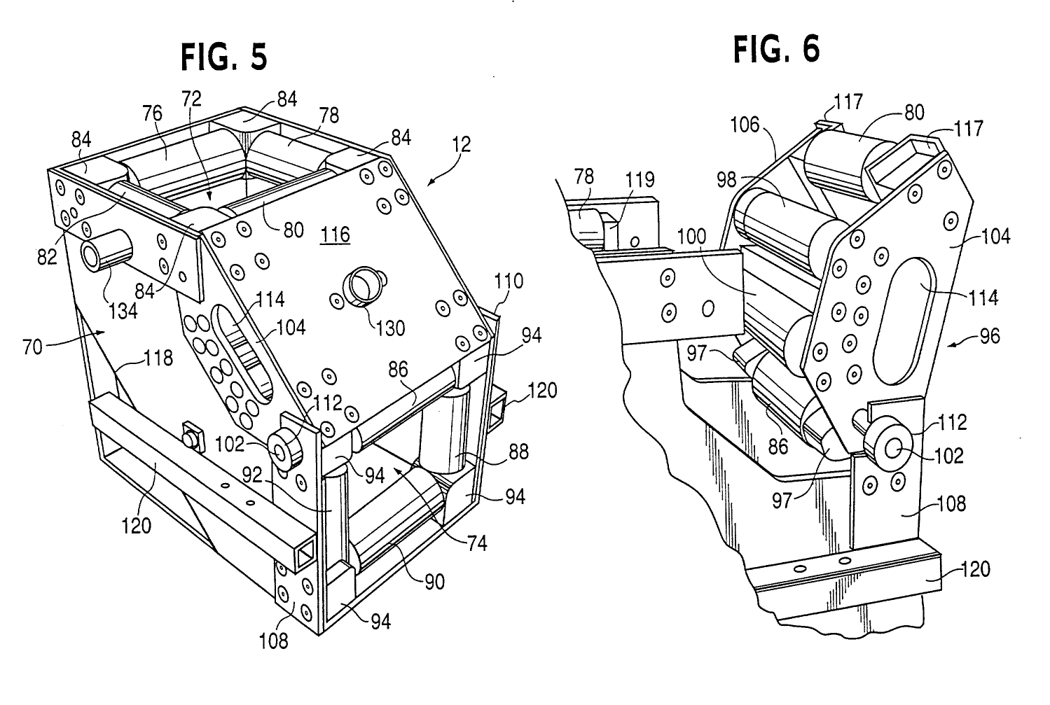

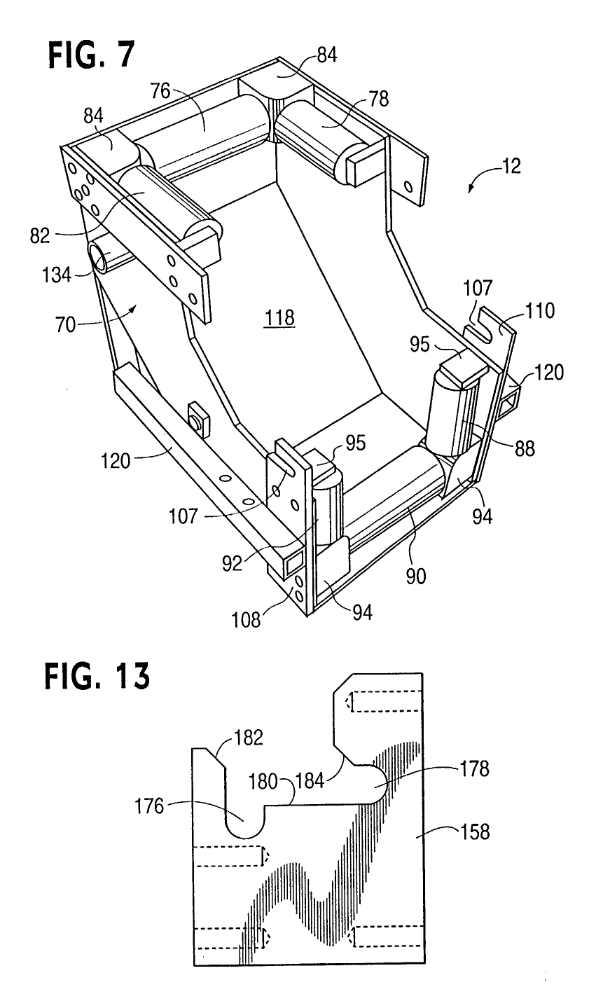

As shown in FIG. 5, the lower section 12 comprises a casing 70 with a rectangular inlet 72 at the top and a rectangular outlet 74 at one end. The inlet is defined by four rollers 76, 78, 80, and 82 that rotate on corner blocks 84 about substantially horizontal axes. The outlet 74 is defined by four rollers 86, 88, 90, and 92 that rotate on corner blocks 94. One pair of opposed rollers, 86, 90, rotates about substantially horizontal axes and the other pair of opposed rollers, 88, 92, rotates about substantially vertical axes. The corner blocks 94 shown at the top of rollers 88 and 92 in FIG. 5 are actually formed in two parts. Portions 95 of these corner blocks are shown in FIG. 7, and mating portions 97 are shown in FIG. 6.

As shown in FIG. 6, the lower section 12 has a displaceable and removable portion 96 that supports one of the rollers, 80, of the inlet 72 and one of the rollers, 86, of the outlet 74, as well as two additional rollers 98, 100 that are rotatable about substantially horizontal axes. Short rods 102, one of which is shown in FIG. 6, project from side plates 104 and 106 of the removable portion 96 and are received in slots 107 (FIG. 7) in sidewall portions 108 and 110 of the lower section. The ends of the projecting rods may have washers 112 fixed thereto.

Openings 114 in the side plates of the removable portion provide hand grips to permit the removable portion to be turned from the position shown in FIG. 5 to the position shown in FIG. 6, whereupon the projecting rods 102 can be displaced from their slots 107 so that the removable portion can be removed from the lower section. The lower section will then appear as shown in FIG. 7. The removable portion 96 has a cover plate 116 that closes off the lower section above the outlet 74 when the removable portion is in the position shown in FIG. 5. In this position angle pieces 117 shown in FIG. 6 mate with plates 119 to form the corner blocks 84 adjacent to the plate 116.

As shown in FIGS. 5, 7, and 8, the lower section 12 has an inclined plane defined by a sloping wall 118 (or, alternatively, by a series of rollers), angulated at approximately 45° with respect to horizontal. The rollers 98 and 100 of the removable portion are opposed to the sloping wall 118 and define a tangent plane that is substantially parallel to the sloping wall.

As shown in FIGS. 5-9, a pair of rectangular cross section tubes 120 are attached to opposite sides of the lower section. Rectangular cross-section rods 122, one of which is shown in FIG. 8, can be inserted through the tubes so as to project from opposite ends thereof and can be fixed in position in the tubes by inserting pins (not shown) through aligned bores in juxtaposed walls of the rods and the tubes. The projecting ends can serve as handles for lifting and lowering the lower section.

Projecting ends of the rods 122 also serve to support a cooling manifold 124, the base of which has rectangular cross-section tubes 126 that receive respective rod ends and that are pinned in position. A threaded fitting 128 at the top of the manifold is provided so that a hose can be attached to the manifold to supply cooling water. A similar fitting 130 provided on the cover plate 116 of the removable portion as shown in FIGS. 5, 8 and 9, can be connected to a hose for additional cooling if desired. FIG. 10 is an inverted view of the manifold showing a plurality of holes 131 through which water is ejected. A baffle or baffles (not shown) can be provided in the manifold to distribute the supply of water evenly to all of the holes.

To assemble the upper section 10 with the lower section 12 as shown in FIGS. 8 and 9, the upper section is lowered onto the top of the lower section until bars 132, one of which is shown in FIG. 1, that extend between pairs of plates 50 rest on corner blocks 84 at the top of the lower section. The pins 52 (FIG. 8) are then inserted, as described earlier, to lock the upper section to the lower section. The lower section has projecting tubulations 134 for receiving jack screws 136, the purpose of which will be apparent in the following description.

A typical application of the invention to provide a folded plastic liner in a sewer pipe will now be described.

It is well known in the art to pull a folded thermoplastic liner through a sewer pipe or the like by a pulling cable that is attached to a leading end of the liner. The coupling between the cable and the liner may include a ball and a swivel. The flattened liner may be supplied from a reel on which the liner is wound, the reel being placed in a steam cabinet to soften the thermoplastic liner material prior to its being fed into the machine of the invention. The machine of the invention can be installed below ground in a manhole, supported on a ledge directly or with intermediate support members and can be braced in position by means of the jack screws 136. The top of the upper section 10 is positioned below the ground level opening to the manhole, and the outlet 74 of the lower section 12 is aligned with an entry opening of the sewer pipe.

An initial portion (e.g., two feet) of the liner attached to the coupling of the cable pulling assembly can be pre-folded above ground and taped to maintain the folded configuration. To facilitate insertion of the cable pulling assembly and the leading end of the liner into the upper section, the removable portion 16 and the unit 142 of the upper section can be removed, or simply turned out of the way. Unit 142 can be turned out of the way by turning the handle 156 until it is approximately horizontal. Once the liner has been properly inserted through the upper section 10, the removable portion 16 shown in FIG. 2 is installed as shown in FIG. 1. The handle 156 of unit 142 is turned upwardly into the position shown in FIG. 12 to seat the unit 142 in the upper section and to insert the divider disk 144 into a longitudinal groove of the folded liner configuration, as described more fully hereinafter. The handle may then be removed. Installation of the machine of the invention in the manhole is simplified by the separability of the upper and lower sections, so that the lower section can be installed in the manhole first and then the upper section installed atop the lower section.

The liner fed downwardly into the upper section has a flattened elongated cross-section L that passes between the bulbous forming roller 22 and the backup roller 48 as shown in FIG. 4. The forming roller forms a broad indentation in one side of the liner cross-section, and has been found to be particularly effective in initiating the folding of the liner and in smoothing out dimples or other imperfections in the heated liner. As the liner is fed downwardly through the upper section 10, it is folded and is surrounded and embraced by the rollers 146, 160, and 166, as shown in FIG. 3. The liner is folded about a longitudinal axis at a central region and defines a pair of outer loops L1 and L2 disposed at opposite sides of a central loop L3, with loop cross-sections arranged side-by-side in a substantially horizontal direction. As shown, the central loop L3 is open at one side of the liner and provides a longitudinal groove facing one side of the machine, into which the divider disk 144 is inserted.

FIG. 3 shows the desired orientation of the liner as the liner exits the upper section 10. In the absence of the stabilizing assembly 140, it is possible for the liner fed through the upper section of the machine to twist or turn about its longitudinal axis, undesirably. The open side of the folded liner, i.e., the open end of loop L3, may momentarily turn by 90° left or right or even by 180°, significantly increasing the force required to pull the liner through the machine and unduly stressing the liner. The stabilizing assembly 140 constrains the liner laterally by trapping the liner between the rolls 146, 160, and 166, which form a group of guides that engage respective sides of the folded liner. With divider disk 144 inserted in the longitudinal groove at one side of the folded liner, rotation of the liner about a longitudinal axis is prevented, thereby maintaining the desired orientation and folded configuration, regardless of the operator's skill level or the temperature of the liner.

As the folded liner is fed downwardly from the upper section 10 into the lower section 12, it enters a direction-changing passage defined between the sloping wall 118 and the rollers 98 and 100 of the lower section, which redirects the liner in a feed direction transverse to the feed direction in the upper section so that it is fed substantially horizontally from the outlet 74 of the lower section. With the liner so redirected, the outer loops L2 and L1 are disposed above and below the central loop L3, with the loop cross-sections arranged side-by-side in a substantially vertical direction and with the longitudinal groove provided by the open loop L3 facing the same side of the machine as in the upper section, as shown in FIG. 9. As the folded liner leaves the lower section it is cooled by cooling water supplied to the cooling manifold 124 to reduce the flexibility of the liner in order that its folded configuration can be maintained as the liner is pulled through the sewer pipe to the desired extent.

When the liner pulling is complete, it is necessary to remove the machine from the liner. The construction of the machine of the invention greatly facilitates such removal. The removable portion 16 and the unit 142 of the upper section can be removed, so that the upper section can then be lifted and shifted laterally of the liner to pass the liner between the edges 65 in FIG. 3, thereby to separate the upper section from the liner and permit the upper section to be extracted from the manhole. Then the removable portion 96 of the lower section can be removed, so that the top and one side of the lower section are open as shown in FIG. 7. The lower section can then be shifted and lifted to separate it from the liner and to extract it from the manhole. A trailing portion of the liner above ground can then be cut so that the installation of the liner can be completed using conventional techniques to soften and expand the liner to the desired round cross-section.

While a preferred embodiment of the invention has been shown and described, it will be apparent to those skilled in the art that modifications can be made without departing from the principles and spirit of the invention as defined in the appended claims. For example, the machine of the invention can be used above ground, rather than in a manhole, and can be used to provide folded tubing in applications other than sewer pipe lining. Also, the upper section can be used by itself to supply folded tubing to a vertical pipe, for example. Furthermore, terms such as “substantially vertical” and “substantially horizontal” are relative terms used herein in describing preferred orientation of axes, for example, and the redirection of the liner from the upper section through the lower section, but it is to be understood that the liner feed need not be along strictly vertical or horizontal directions. For example, the liner fed from the lower section can be provided to a sloping pipe, which, within the context of the invention, is to be considered as “substantially horizontal”.

The invention claimed is:

1. Apparatus for stabilizing tubing that is folded about a longitudinal axis to form overlapping loops, including a central loop open along an end thereof and loops at opposite sides of the central loop, said apparatus comprising:
a group of guides which surround the folded tubing and constrain the folded tubing laterally, and a divider that is inserted into the open end of the central loop.

2. Apparatus according to claim 1, wherein the guides include a first roll disposed to engage the liner opposite to the open end of the central loop and second and third rolls disposed to engage the outer loops at opposite sides of the liner.

3. Apparatus according to claim 2, wherein the first roll is concave.

4. Apparatus according to claim 2, wherein the second and third rolls converge toward the first roll.

5. Apparatus according to claim 2, wherein the guides include a fourth roll disposed to engage the outer loops at a side of the liner opposite to the first roll.

6. Apparatus according to claim 5, wherein the divider comprises a disk supported centrally on the fourth roll.

7. Apparatus according to claim 6, wherein the fourth roll and the disk are parts of a removable unit.

8. Apparatus according to claim 7, wherein the first, second, and third rolls are mounted in a casing having an opening through which the unit can be inserted into or removed from the casing, and wherein the casing has supports at opposite sides of the opening on which the unit is mountable.

9. Apparatus according to claim 8, wherein the unit comprises a frame which supports the fourth roll.

10. Apparatus according to claim 9, wherein the frame has blocks at opposite sides of the fourth roll and on which the fourth roll is mounted, each block having a pair of outwardly projecting spaced rods and wherein the supports for the unit in the casing include a pair of plates with notches disposed to receive respective pairs of the rods therein.

11. Apparatus according to claim 10, wherein the configuration of the notches is such that the spaced rods can be shifted into the respective notches and so that the unit can then be turned on the plates to lock the unit at a position in which the disk is disposed to enter the open end of the central loop of the tubing.

12. A machine for supplying a folded liner to a pipe, comprising:
an upper section that folds a flattened downwardly-fed tubular liner to form three overlapping loops including a central loop with an open end and outer loops at opposite sides of the central loop as the liner is fed through the upper section; and
a lower section that receives the folded liner from the upper section and that redirects the liner so that the liner is fed transversely to the feeding of the liner in the upper section and with the loops disposed so that one of the outer loops is above the central loop and the other outer loop is below the central loop; and wherein:
the upper section includes a stabilizing assembly having a first guide disposed to engage a side of the liner opposite to the open end of the central loop, second and third guides disposed to engage respective outer loops at opposite sides of the liner, a fourth guide disposed to engage the liner opposite to the first guide, and a divider disposed to enter the open end of the central loop.

13. A machine for supplying folded tubing, comprising:
a first section, through which flexible tubing is fed downwardly and that shapes the tubing into a folded configuration having a groove that extends longitudinally and substantially vertically at one side of the tubing and that faces one side of the machine, the first section having a stabilizing assembly that constrains the folded configuration to maintain the groove facing said one side of the machine; and
a second section below the first section that receives the folded tubing from the first section and that redirects the folded tubing so that it is fed through the second section with the groove facing said one side of the machine and so that the folded tubing exits the second section substantially horizontally.

14. A machine according to claim 13, wherein the stabilizing assembly comprises a first roll disposed to engage a side of the tubing opposite to the groove, second and third rolls disposed to engage the folded tubing transversely of the groove at opposite sides thereof, a fourth roll disposed to engage the folded tubing at the same side thereof as the groove, and a divider disposed to enter the groove.

15. A machine according to claim 14, wherein the first roll is concave and the second and third rolls converge toward the first roll.

16. A machine according to claim 15, wherein the first section has an opening at one side thereof and the second, third, and fourth rolls and the divider form a unit that is displaceably mounted on the first section adjacent to the opening.

17. A machine according to claim 14, wherein the first section has a portion that flattens the tubing before it is folded.

18. A machine according to claim 17, wherein the portion that flattens the tubing includes a bulbous roller that forms a broad indentation in said one side of the tubing.

19. A machine according to claim 18, wherein said bulbous roller is mounted on the first section displaceably to facilitate entry of the tubing into the first section and removal of the first section from the tubing.

20. A machine according to claim 13, wherein the second section has a portion that is mounted thereon displaceably to facilitate removal of the second section from the tubing.

21. A machine according to claim 13, wherein the second section has a group of rollers defining an inlet into the second section and a group of rollers defining an outlet from the second section.

22. A machine according to claim 21, wherein a portion of each group of rollers is displaceably mounted on the second section to facilitate removal of the second section from the tubing.

23. A machine according to claim 21, wherein the second section has an angulated path therein for the folded tubing, and wherein the path is defined in part by at least a roller located between the inlet and the outlet.

24. A machine for supplying folded tubing, comprising a casing through which flexible tubing is fed downwardly and in which the tubing is folded so that a cross-sectional configuration of the tubing is changed from a flattened configuration broadly indented at one side to a folded configuration having a groove extending longitudinally of the tubing at said one side, further comprising a stabilizing assembly that surrounds the folded tubing to constrain the folded tubing and to maintain the orientation of the groove, wherein the stabilizing assembly includes a plurality of guides disposed to engage respective sides of the folded tubing and a divider disposed to enter the groove.

25. A machine according to claim 24, wherein the casing has mounted thereon a bulbous roller that forms a broad indentation at said one side of the tubing before the tubing is folded.

26. A machine according to claim 25, wherein the bulbous roller is part of a flattening assembly that includes a backing roller adjacent to the bulbous roller, and wherein the bulbous roller is mounted displaceably on the casing to facilitate insertion of the tubing into the casing and removal of the casing from the tubing.

27. A machine according to claim 24, wherein the casing has an opening at one side thereof to which said side of the tubing faces, and wherein said stabilizing assembly includes a unit that is mounted displaceably on the casing adjacent to the opening in the casing to facilitate removal of the casing from the tubing via the opening in the casing.

28. In a machine for supplying a folded tubular liner to a pipe and in which a tubular liner is folded so as to provide a longitudinal groove at one side of the folded liner, a casing constructed for removable insertion in a manhole and having an inlet through which the folded liner is fed substantially vertically and an outlet through which the folded liner is fed substantially horizontally, the casing having a structure therein that guides the folded liner from the inlet to the outlet along a path that extends at an angle to the substantially vertical and substantially horizontal feed directions, and with the groove facing towards a same side of the casing as the liner is fed through the casing,
wherein the casing has a stabilizing assembly therein that surrounds and constrains the folded liner to maintain the orientation of the groove.

29. A method of providing folded tubing, comprising:
feeding flexible tubing in a first feed direction in a machine and then in a second feed direction in the machine transverse to the first feed direction;
shaping the tubing fed in the first feed direction in the machine into a folded configuration having a groove that extends longitudinally at one side of the tubing and that faces one side of the machine; and
constraining the tubing to maintain the folded configuration and to maintain the groove facing said one side of the machine by surrounding the folded tubing with a plurality of guides disposed to engage respective sides of the folded tubing and by inserting a divider into the groove of the folded configuration.

30. A method according to claim 29, wherein the tubing is flattened before it is shaped into the folded configuration.

31. A method of providing a folded liner to a pipe leading from a lower portion of a manhole, comprising:
providing a machine having an upper section for folding a flexible tubular liner and a lower section for redirecting the folded tubular liner;
installing the lower section in the manhole with an inlet of the lower section facing upwardly and an outlet of the lower section facing into the pipe;
installing the upper section on the lower section with an outlet of the upper section facing the inlet of the lower section;
feeding flexible tubing downwardly through the upper section and into the lower section while folding the tubing to provide a longitudinal groove at one side of the tubing facing one side of the machine; and
feeding the folded tubing through the lower section into the pipe while redirecting the tubing from a substantially vertical feed direction to a substantially horizontal feed direction and while maintaining the groove facing the same side of the machine,
wherein the groove is maintained facing the same side of the machine by a stabilizing assembly in the upper section that surrounds and constrains the folded tubing and that inserts a divider into the longitudinal groove.

32. A method according to claim 31, wherein after the folded liner is fed into the pipe, the upper section is removed from the liner via an opening in the upper section, the lower section is removed from the liner via an opening in the lower section, and both the upper section and the lower sections are removed from the manhole.

33. A method of providing folded tubing, comprising:
feeding, in a first feed direction, flexible tubing having a flattened cross-section;
folding the fed tubing to transform the tubing into overlapping loops having cross-sections disposed side-by-side in a first arrangement direction; and
redirecting the fed tubing so that the loop cross-sections of the same loops are reoriented to be disposed side-by-side in a second arrangement direction,
wherein the folded tubing has a longitudinal groove and the disposition of the loops relative to each other is maintained by surrounding and constraining the loops and inserting a divider into the longitudinal groove before redirecting the fed tubing.
